(19) United States
(12) Patent Application Publication
(10) Pub. No.: US 2017/0216695 A1
(43) Pub. Date: Aug. 3, 2017

(54) METHOD OF PERFORMING AND MEASURING RUNNING THROWS

(71) Applicant: Gary Schlagenhauf, Walnut Creek, CA (US)

(72) Inventor: Gary Schlagenhauf, Walnut Creek, CA (US)

(21) Appl. No.: 15/416,209

(22) Filed: Jan. 26, 2017

Related U.S. Application Data
(60) Provisional application No. 62/290,135, filed on Feb. 2, 2016.

(51) Int. Cl. A63B 69/00; A63B 24/00; G04F 13/02

(52) U.S. Cl. CPC A63B 69/0002; G04F 13/02; A63B 24/0021; A63B 2208/0204; A63B 2024/0034; A63B 2220/62

(57) ABSTRACT

The present invention is a method for measuring and performing a throwing technique. The method of performing the technique includes the steps of: running toward a location with a ball in the non-throwing hand, crossing the location and transferring the ball to the throwing hand, and throwing the ball to a destination. The method of measuring the technique includes the steps of: beginning time measurement at the moment a thrower crosses a location, stopping time measurement at the moment a ball reaches a destination, and factoring potential environmental elements into the measured time to determine a running throw value.

### CROSS-REFERENCE TO RELATED APPLICATIONS

This application claims priority to U.S. Provisional Application No. 62/290,135 filed Feb. 2, 2016. The content of the above application is incorporated by reference in its entirety.

### FIELD OF THE DISCLOSURE

This disclosure relates generally to the field of throwing object competitions, and more specifically to throwing baseballs while running competitions.

### BACKGROUND

Baseball is America's pastime, and its records are kept to track the achievements and performance of teams and players. Players and teams in every league and at every skill level benefit from statistical records that track players' strengths at particular positions and highlight areas that need improvement. There are numerous types of records for different achievements at different positions, including statistics for home runs for batters, earned run averages for pitchers, and stolen base percentages for runners. However, there has never been a precise metric that measures and compares outfielder's capacity to throw out runners.

Currently, baseball throws are measured and evaluated in the following areas: the distance between the thrower and where the ball first strikes the ground, the ball's overall average speed calculated by dividing the distance the ball travels by its time of flight,; and the initial throw velocity. None of these throw evaluations focus on the ability of an outfielder to make a running throw to a baseman. Having a standardized technique and measurement system for this statistic would greatly improve a team's ability to place players skilled in running throws in outfield positions, and would greatly improve a player's ability to focus on improving a very important on-field skill.

The standardized competition disclosed here will allow anyone in the world, with or without a baseball field, to compete for the fastest world record times. This will vastly enhance and expand the coordinated quickness, precision, and accuracy of players by encouraging competition at the statistical level. The challenge of achieving a positive running throw statistic will contribute to keeping players interested in throw performance as they mature. Historically, many children have not participated in throwing competitions because the limited amount of throwing competitions available are consistently dominated by pitchers and catchers. Measuring throws by pitchers and catchers has long been a focus of throwing statistics, since their positions have a heavy reliance on throwing and the distance of their throws are largely uniform and consistent. The lack of a running throw measurement technique and competition allowing the comparison of a standardized running throw ability deprives young outfielders the ability to compete in throwing contests traditionally dominated by players who focus on fixed-place throws. Professional and amateur teams are deprived of the ability to optimize their outfielder positions by using players with the highest statistical running throw records.

Inclusion of a running throw competition and statistic will cause a sea change in baseball. Outfielders will be trained to attempt to throw out runners in game situations where before no throw would have been attempted. Since momentum is a critical element in a running throw; coordination, running speed, and quickness of release will easily overcome arm strength alone. Games will be more exciting as plays are made that were before thought impossible Crowds will roar in pleasure and seats will fill.

For the foregoing reasons, there is a need for a method for measuring and performing running throws. This will prompt a significant change in baseball as outfielders no longer “camp” as often under fly balls but catch and throw balls on the run. Runners will be thrown out in situations where in the past no throw would have been attempted. This sea change in baseball will thrill fans both old and new.

### SUMMARY

The disclosure presented herein relates to a method of measuring and performing running throw competitions. In one embodiment running throws are compared in a competition where a runner approaches a demarked line and throws a ball at a small target while running. A larger target sits behind the smaller target and catches balls that miss the smaller target. In other embodiments, a method for measuring a running throw may comprise defining a first location and a second location of a playing surface and measuring the amount of time between the moment a thrower passes said first location of said playing surface and the moment that a throwing object passes said second location of said playing surface, wherein said amount of time defines a running throw value. Said throwing object may be a baseball, and said first location and said second location of said playing surface may each comprise a planar area positioned perpendicularly above said playing surface. These first and second locations of said playing surface may be predetermined. The method may further comprise defining a third location of said playing surface that may be positioned linearly between said first location and said second location of said playing surface, wherein said thrower may pass said first location of said playing surface toward said second location of said playing surface, and wherein said third location may define the linear point between said first location and said second location of said playing surface where the throwing object departs from said thrower. Where the thrower begins the transfer of the throwing object from his non-throwing hand to his throwing hand may define the first location. Once passed this location the thrower may throw the throwing object while running.

In some embodiments a first location may be defined as a location where an object is transferred from a non-throwing hand to throwing hand. The object would be thrown to a second location 90 to 360 feet from the first location while the thrower continues running. Both locations may be predetermined and may comprise a planar area positioned perpendicularly above said playing surface. Once the object reaches the second location a running throw value consisting of the time elapsed between when the object or the thrower passes the first location and the object reaches the second location can be calculated. Environmental factors such as air resistance, wind speed and/or direction, air pressure, temperature, precipitation, humidity, altitude, elevation, playing surface material and/or conditions, presence or absence of a glove, size of and/or distance to target area, along with throwing object size, weight, type, and/or shape.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 is a side view of an individual participating in a running throw competition.

FIG. 2 is a flow diagram showing the steps of calculating a running throw value.

FIG. 3 is a perspective drawing of a running throw made on a baseball diamond.

FIG. 4 is a perspective drawing of a second embodiment of a running throw made on a baseball diamond.

### DEFINITIONS

Playing Surface: Any substantially flat surface or other area where a running throw may be performed. This may refer to the ground surface of a field, a gymnasium, an arena, or any other area.

Throwing Object: Any object capable of being thrown or launched, either by a human or a machine or other apparatus. This may refer to any such object regardless of whether it is actually thrown, and it may refer to any such object before, during, and after it is thrown.

Thrower: A human or machine or other apparatus that throws an object. This could refer to a human, such as a baseball player, or a robot or a non-mechanical device.

Non-throwing Hand: One of two hands possessed by a thrower. This hand does not perform a throw.

Throwing Hand: One of two hands possessed by a thrower. This hand performs a throw.

Playing Field Location: A point, line, area, or space on or above a playing surface. A location may be represented tangibly through physical markers or boundaries, or intangibly through coordinates relative to a playing surface.

Running Throw: A competition in which a thrower runs up to a starting line and while running throws a baseball toward at least one target positioned 90 to 360 feet from the line.

Running Throw Value: A numeric value for a running throw incorporating at least: (1) the time elapsed between when the runner crosses the starting line and the ball reaches the target and (2) the accuracy of the ball's flight toward the target.

### DETAILED DESCRIPTION

Preceding and following embodiments and descriptions are for illustrative purposes only and are not intended to limit the scope of this disclosure. Other aspects and advantages of this disclosure will become apparent from the following detailed description.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose limit is the second number. For example, 25 to 100 mm means a range whose lower limit is 25 mm and upper limit is 100 mm.

The present invention relates to a method for performing and measuring a running throw technique for children and adults.

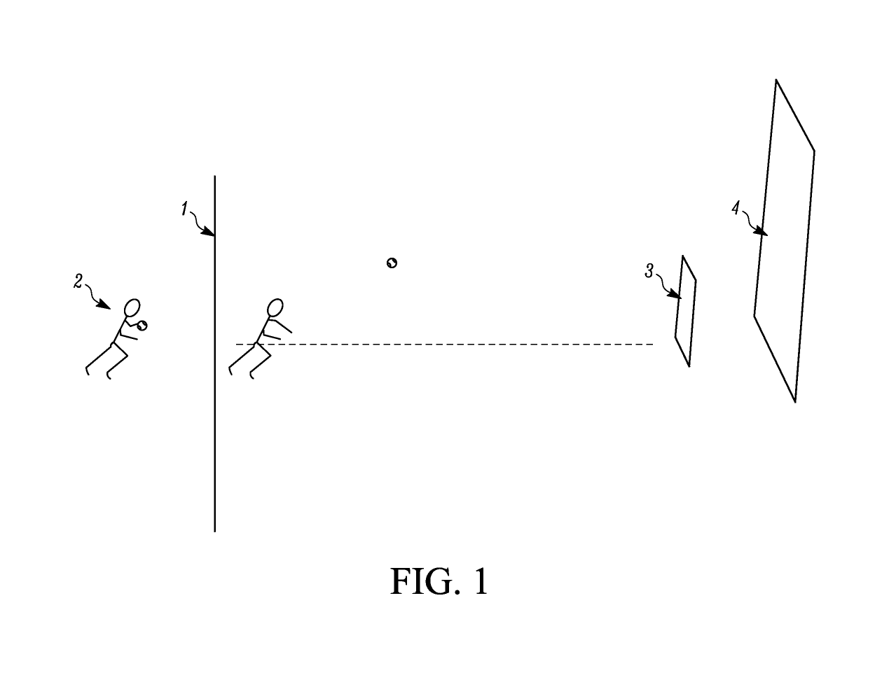

In one embodiment the invention consists of a competition to compare running throw values between different individuals. This competition is referred to as Running Throw or The Running Throw Competition. In an area of a length above 360 feet and wide enough to safely allow errant throws, a line 1 is marked on the ground and a target or targets are placed 90 to 360 feet away from the line. As shown in FIG. 1, an individual 2 runs up to the line 1 and while running throws a baseball at the target or targets. The time the runner crosses the line 1 is measured such as, in a non-limiting example, by the breaking of a light or laser beam. The thrower cannot transfer the ball to the throwing hand until the line is crossed. In a preferred embodiment a sound is produced when the thrower crosses the line 1 and the ball can be transferred to the throwing hand. In a preferred embodiment, as seen in FIG. 1, two targets are placed 90 to 360 feet from the starting line. A 24 inch square target 3 is placed at the distance to be tested while a six foot square target 4 is placed ten feet behind the 24 inch square target 3. Impact or vibration sensors, in a non-limiting example, stop the time recording when the ball hits either of the targets. The extra time the ball takes to reach the six foot target 4 is the penalty for missing the ideal throw represented by the 24 inch target 3. Throws that miss either target are also recorded and are as much a part of the players profile as any other throw.

In another embodiment the smaller target imitates an infielder moving to tag out a runner. The target does this by moving either horizontally or diagonally at a speed reminiscent of the speed of an infielder.

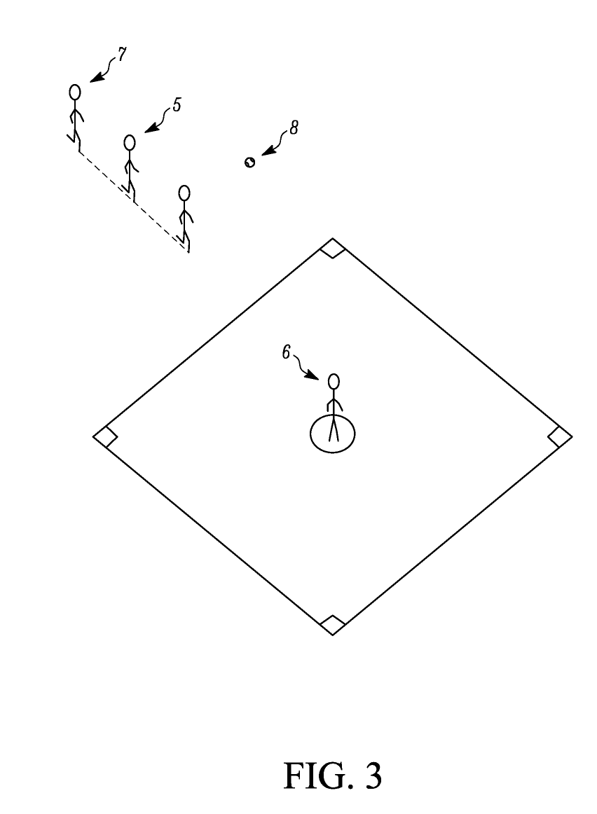

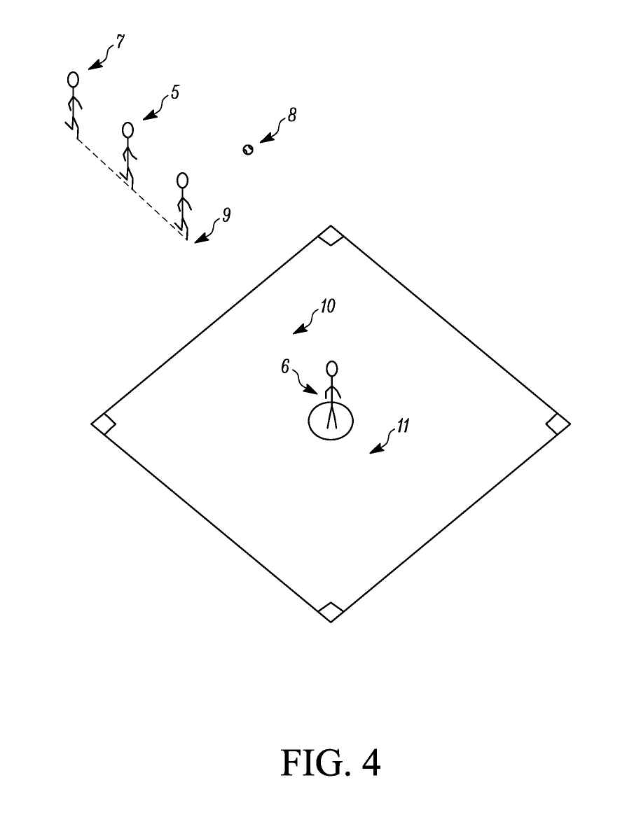

In another embodiment a method for measuring a running throw, as shown in FIG. 3 comprises the steps of (1) defining a first location 5 and a second location 6 of a playing surface; and (2) measuring the amount of time between the moment a thrower 7 passes the first location 5 and the moment that a throwing object 8 passes the second location 6; (3) wherein this amount of time defines a running throw value. The method may additionally comprise, as shown in FIG. 4, one or more of the following steps, including (4) defining a third location 9 of a playing surface positioned between the first location 5 and second location 6, as the location where a throwing object 8 departs from the thrower 7; (5) defining the first location 5 as the location of a playing surface where a thrower 7 initiates or completes a transfer of a throwing object 8 to a throwing hand; (6) wherein the thrower 7 passes the first location 5 by running over or through it; (7) wherein the thrower 7 throws the throwing object 8 while running; (8) establishing a fourth location 11 of the playing surface behind the second location 6; and (9) measuring a second amount of time between the moment the thrower 7 or throwing object 8 reaches or passes over or through the first location 5 and the moment the throwing object 8 reaches or passes over or through the fourth location 11; (11) wherein the second amount of time defines an adjusted running throw value.

The playing surface may be a baseball field or other substantially flat surface, such as a field or indoor floor. The first location 5, second location 6, third location 9, and fourth location 11 may each represent a point, line, or area on a playing surface, such as the outfield of a baseball field or a base or pitcher's mound of a baseball infield, or a point, line, area, or space above such point, line, or area on a playing surface. An area of the first location 5, second location 6, third location 9, or fourth location 11 may be represented non-physically, such as an area defined by its coordinates relating to the playing surface, or may be represented by lighting or lasers, or may be represented by a physical barrier 3 or boundary 4 defining the area, or other physical material representing the area. The first location 5, second location 6, third location 9, and fourth location 11 may each be predetermined or may be defined as the location of a playing surface where an action occurs, such as a throwing object 8 being tossed, transferred between hands, landing, reaching a destination, or other actions, or where a thrower 7 performs one of such or other actions. The thrower 7 may be a human or a machine, device, or apparatus.

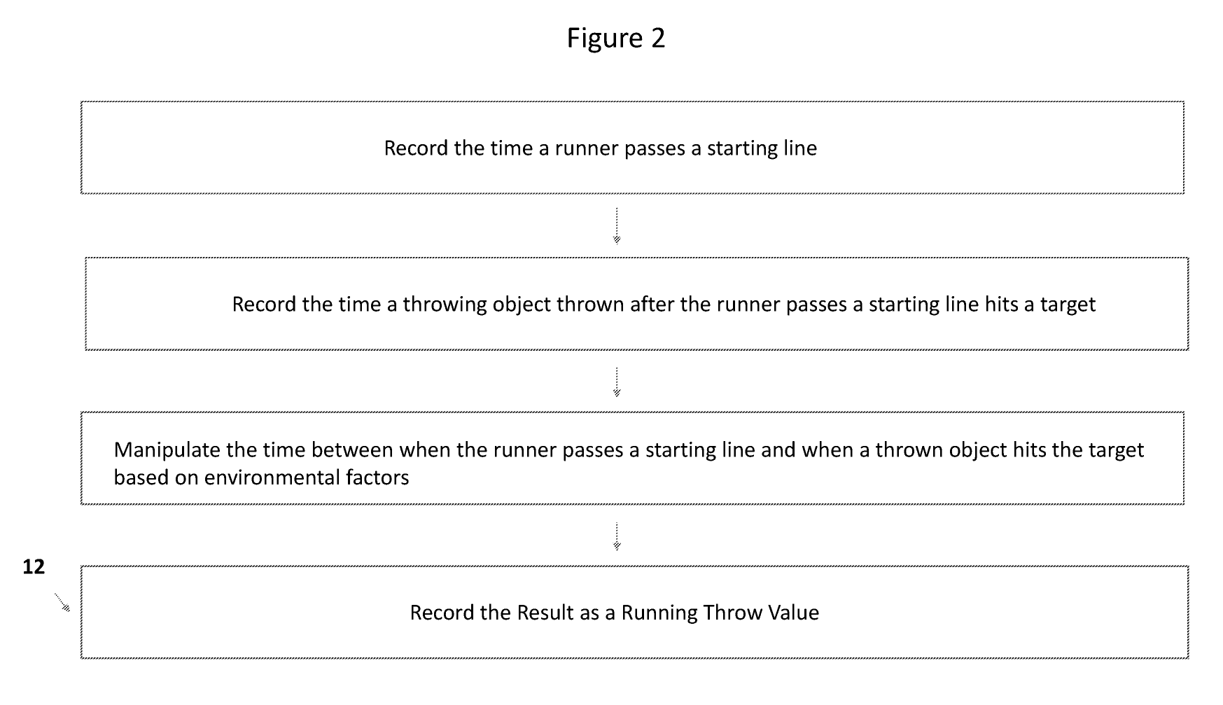

The running throw value 12, as shown in FIG. 2, may be defined as the amount of time between (1) the moment a thrower 7 reaches or passes the first location 5, or the moment a throwing object 8 reaches or passes the first location 5; and (2) the moment a throwing object 8, such as a baseball, reaches or passes the second location 6. The running throw value 12 may be defined as the amount of time between (1) the moment a thrower 7 reaches or passes the first location 5, or the moment a throwing object 8 reaches or passes the first location 5; and (2) the moment a throwing object 8, such as a baseball, reaches or passes the fourth location 11. The third location 9 may be defined as the location where the thrower 7 or the throwing object 8 is located at the moment (1) the thrower 7 initiates or completes a transfer of the throwing object 8 to a throwing hand, either from another hand or a glove; or (2) the thrower 7 releases the throwing object 8, such as from a throwing hand. The first location 5 may be defined as the location where the thrower 7 or throwing object 8 is located at the moment the measurement of time begins, and wherein a thrower 7 may have a baseball in a glove or non-throwing hand.

The time may be measured by a timer, watch, or other chronograph. The position of the throwing object 8 and thrower 7 may be monitored, observed, or recorded by a video capturing device, laser system, light system, radar system, or other location detection device or system, or without a device using an unaided eye. These position devices and systems may be configured to automatically engage with timing devices and systems. The time, of a throwing object 8 or thrower 7 may be measured or calculated at the first location 5, second location 6, third location 9, fourth location 11, or any other location positioned at, before, behind, or between the aforementioned locations on or above a playing surface. The measurements and calculations can be transmitted to and displayed on computer devices, or other electronic and digital display devices. Measurements and calculations may be represented to 1/100^{th} of a second or more precisely, and the throwing object's 8 position in motion may be measured or calculated in ten foot or smaller increments. The first location 5 and third location 9 may each be the location of or a location in a baseball field's outfield, while the second location 6 and fourth location 11 may each be the location of or a location in a baseball field's infield. The second location 6 could, in non-limiting examples, be located at a base, home plate, or the pitcher's mound. A human thrower 7 may be measured to determine that person's running throw value. A machine, device, or apparatus thrower or human thrower 7 may be measured to determine a standard or goal running throw value

Another method for calculating a running throw value 12 comprises the steps of (1) defining a first location 5 and second location 6 on or above a playing surface; (2) measuring the amount of time between the moment at which a throwing object 8 reaches, passes over, or passes through the first location 5 and the moment at which the throwing object 8 reaches, passes over, or passes through the second location; and (3) factoring environmental elements along with the amount of time to define the running throw value 12. The throwing object may be a baseball, and the environmental elements may be air resistance, wind speed, wind direction, air pressure, temperature, precipitation, humidity, altitude, elevation, playing surface material, playing surface conditions, throwing object type, throwing object shape, throwing object size, throwing object weight, presence of a glove, absence of a glove, size of target area, and distance of target area. These environmental elements may be factored into the measured time to calculate the running throw value 12 by assigning a numerical value to each environmental element based on the measurement of the environmental element and conversion of the measured value to an assigned time value in fractions of a second, then by adding, subtracting, multiplying, dividing, or performing another mathematical function the assigned time value of the environmental element to the numerical value to the measured time. The environmental elements may be measured by any means or methods known in their respective areas of art.

While preferred and alternate embodiments have been illustrated and described, as noted above, many changes can be made without departing from the spirit and scope of the METHOD OF PERFORMING AND MEASURING RUNNING THROWS. Accordingly, the scope of the METHOD OF PERFORMING AND MEASURING RUNNING THROWS is not limited by the disclosure of these preferred and alternate embodiments. Instead, the scope of the METHOD OF PERFORMING AND MEASURING RUNNING THROWS should be determined entirely by reference to the claims. Insofar as the description above and the accompanying drawings disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. §112 ¶ 6. In particular, the use of “step of” in the claims herein is not intended to invoke the provisions of U.S.C. §112 ¶ 6.

I claim:

1. A method of performing a baseball throwing competition comprising:
indicating a starting line;
having a thrower positioned behind the starting line;
wherein the thrower has a baseball;
wherein the thrower runs past the starting line;
placing a 24 inch square target 90 to 360 feet away from the starting line;
placing a 6 foot square target behind the 24 inch square target; and
determining the time elapsed from when the thrower crosses the starting line to when the baseball strikes a target.

2. The method of claim 1 wherein:
the time is determined by direct measurement.

3. A method for measuring a throw comprising:
defining a first location and a second location of a playing surface; and
determining the amount of time between the moment a thrower crosses the first location and the moment that a throwing object reaches the second location.

4. The method of claim 3 wherein:
the time is directly measured.

5. The method of claim 1 wherein:
the thrower breaks a beam of radiation by crossing the starting line allowing the moment he crosses to be accurately recorded.

6. The method of claim 1 wherein:
crossing the starting line triggers an auditory or visual cue indicating the baseball can be thrown.

7. The method of claim 5 wherein:
breaking the beam of radiation triggers an auditory or visual cue.

8. A method of performing a running throw competition comprising:
indicating a starting location;
placing at least one target 90 to 360 feet from the starting location;
determining the time between when a thrower crosses the location and when a baseball strikes a target.

9. The method of claim 8 wherein:
the time is directly measured.

10. The method of claim 1 wherein:
at least one target imitates an infielder by moving.

11. The method of claim 1 wherein:
there are potentially distracting noises throughout the competition.

12. The method of claim 1 wherein:
the thrower may move across the line using non-human, self-powered or mechanical wheelchair means

13. The method of claim 1 wherein:
a thrower may use a prosthetic arm to compete.

14. The method of claim 12 further comprising:
modifying the time based on environmental elements.
